(19) United States
(12) Patent Application Publication
(10) Pub. No.: US 2026/0062058 A1
(43) Pub. Date: Mar. 5, 2026

(54) SIDE MEMBER OF VEHICLE AND SUBFRAME FOR VEHICLE

(71) Applicant: HYUNDAI MOBIS CO., LTD., Seoul (KR)

(72) Inventors: Jong Mook PARK, Yongin-si (KR); Hyun Jin WOO, Yongin-si (KR); Ho Youn HWANG, Yongin-si (KR); Hye Chan PARK, Yongin-si (KR)

(73) Assignee: HYUNDAI MOBIS CO., LTD., Seoul (KR)

(21) Appl. No.: 19/238,778

(22) Filed: Jun. 16, 2025

(30) Foreign Application Priority Data
Aug. 27, 2024 (KR) 10-2024-0115262

(51) Int. Cl. B62D 21/15; B62D 21/03

(52) U.S. Cl. CPC B62D 21/157; B62D 21/03

(57) ABSTRACT

A side member of a vehicle includes a front side member extending in a longitudinal direction of the vehicle, a rear side member extending in the longitudinal direction of the vehicle and disposed at a rear of the front side member, a first side member connecting part having first insertion holes into which the front side member and the rear side member are inserted, and a second side member connecting part having a second insertion hole into which the rear side member is inserted.

### CROSS-REFERENCE TO RELATED APPLICATION

This application claims the benefit under 35 U.S.C. § 119(a) of priority to Korean Patent Application No. 10-2024-0115262 filed on Aug. 27, 2024, in the Korean Intellectual Property Office, the entire disclosure of which is incorporated herein by reference for all purposes.

### BACKGROUND

### 1. Field

Exemplary embodiments of the present disclosure relate to a side member of a vehicle and a subframe of a vehicle, and more particularly, to the side member of the vehicle capable of increasing rigidity at a joint portion between members and the subframe for the vehicle including the side member.

### 2. Description of the Related Art

In general, subframes of a vehicle is divided into a front subframe installed in an engine room and a rear subframe installed at the rear of the vehicle. The front subframe is installed on a body constituting the engine room to support the engine and transmission, and is connected to a suspension device such as a lower arm to increase the structural rigidity of the vehicle while making it easy to transfer the load. The rear subframe is installed on a rear body of the vehicle and is connected to various suspension links to increase the structural rigidity of the vehicle.

Among the subframes, an aluminum subframe is assembled by welding multiple cyber members made of aluminum with aluminum extrusions and joining the cyber members together.

The subframe, which is composed of multiple members welded together, is simple in implementing a specific structure connecting parts of the vehicle body, and thus has limitations in reinforcing the rigidity of the vehicle body. In addition, there is a problem that the weight of the subframe increases overall, and there is a disadvantage that it is difficult to precisely adjust the rigidity to match the target natural frequency.

The background technology of the present disclosure is disclosed in Korean Registered Patent No. 10-1415464 (published on Jun. 27, 2014, entitled “SUBFRAME FOR VEHICLE”).

### SUMMARY

Various embodiments are directed to a side member of a vehicle capable of increasing rigidity at a joint portion between members and simplifying the structure and a subframe for the vehicle including the side member.

In an embodiment of the present disclosure, a side member for a vehicle includes a front side member extending in a longitudinal direction of the vehicle, a rear side member extending in the longitudinal direction of the vehicle and disposed at a rear of the front side member, a first side member connecting part having first insertion holes into which the front side member and the rear side member are inserted, and a second side member connecting part having a second insertion hole into which the rear side member is inserted.

The side member may further include a bracket impact bar fitted to a side of the front side member to absorb impact transmitted to a vehicle body.

The bracket impact bar may include an impact bar body having an assembly hole in which a screw thread is formed, and an impact bar protrusion extending outwardly from the impact bar body and having a narrower width than the impact bar body, and the front side member may include an impact bar insertion hole having a cross-section corresponding to a cross-section of the impact bar protrusion on one side.

In an embodiment of the present disclosure, a subframe of a vehicle includes a pair of side members spaced apart in a width direction of the vehicle, a front cross member part disposed in the width direction of the vehicle and having both ends fitted to the pair of side members, and a rear cross member part disposed in the width direction of the vehicle, located at the rear of the front cross member, and having both ends fitted into the pair of side members. Each of the side members may include front side members spaced apart in the width direction of the vehicle, rear side members spaced apart in the width direction of the vehicle and disposed at the rear of the front side members, a first side member connecting part having first insertion holes into which the front side member and the rear side member are respectively inserted, and a second side member connecting part having second insertion holes into which the rear side members are inserted.

The first side member connecting part may include a first cross member insertion hole having a cross-section corresponding to a cross-section of the front cross member part so that the front cross member part is fitted therein.

The rear side member may include a second cross member insertion hole having a cross-section corresponding to the cross-section of the rear cross member so that the rear cross member is fitted therein.

The rear cross member part may include a rear cross member that is fitted to the rear side member, and a rear cross member bracket that passes through the rear cross member and supports the rear cross member.

The subframe of a vehicle may further include a buffer part disposed in a longitudinal direction of the rear cross member part and assembled to the rear cross member part.

The rear cross member bracket may have a buffer groove at the bottom in which the buffer part is mounted.

The subframe of a vehicle may further include a bracket impact bar fitted to the side of the front side member to absorb impact transmitted to a vehicle body, and a bumper impact bar assembled to the bracket impact bar with a connecting member and having an escape part surrounding the connecting member to prevent damage of the connecting member.

### BRIEF DESCRIPTION OF THE DRAWINGS

FIG. 1 is a perspective view schematically illustrating a side member of a vehicle according to an embodiment of the present disclosure.

FIG. 2 is an exploded perspective view schematically illustrating a side member of a vehicle according to an embodiment of the present disclosure.

FIG. 3 schematically illustrates a front side member of a side member of a vehicle according to an embodiment of the present disclosure.

FIG. 4 schematically illustrates a rear side member of a side member of a vehicle according to an embodiment of the present disclosure.

FIG. 5 schematically illustrates a first side member connecting part of a side member of a vehicle according to an embodiment of the present disclosure.

FIG. 6 schematically illustrates a second side member connecting part of a side member of a vehicle according to an embodiment of the present disclosure.

FIG. 7 schematically illustrates a connection relationship of a side member of a vehicle according to an embodiment of the present disclosure.

FIG. 8 schematically illustrates a bracket impact bar of a side member of a vehicle according to an embodiment of the present disclosure.

FIG. 9 schematically illustrates a subframe of a vehicle according to an embodiment of the present disclosure.

FIG. 10 is an exploded perspective view schematically illustrating a subframe of a vehicle according to an embodiment of the present disclosure.

FIG. 11 schematically illustrates a connection relationship between a front side member and a side member of a subframe of a vehicle according to an embodiment of the present disclosure.

FIG. 12 schematically illustrates a rear cross member part of a subframe of a vehicle according to an embodiment of the present disclosure.

FIG. 13 schematically illustrates a connection relationship between a rear cross member part and a rear side member of a subframe of a vehicle according to an embodiment of the present disclosure.

FIG. 14 schematically illustrates a buffer part of a subframe of a vehicle according to an embodiment of the present disclosure.

FIG. 15 schematically illustrates a bumper impact bar of a subframe of a vehicle according to an embodiment of the present disclosure.

### DETAILED DESCRIPTION

Hereinafter, an embodiment of a side member of a vehicle and a subframe of a vehicle including the same according to the present disclosure will be described in detail below with reference to the accompanying drawings through various exemplary embodiments. It should be considered that the thickness of each line or the size of each component in the drawings may be exaggeratedly illustrated for clarity and convenience of description.

In such a process, the thickness of a line or the size of an element illustrated in the drawings may have been exaggerated for the clarity of a description and for convenience' sake. Terms to be described below have been defined by taking into consideration their functions in the present disclosure, and may be different depending on a user or operator's intention or practice. Accordingly, such terms should be interpreted based on the overall contents of this specification.

In addition, in this specification, when a part is “connected (or connected)” to another part, it includes not only “directly connected (or connected) to another part, but also “indirectly connected (or connected) to” another member in between. In this specification, when a part “includes (or has) a component, this means that other components may be further “included (or has)” rather than excluding other components unless specifically stated to the contrary.

The object and effect of the present disclosure may be naturally understood or made clearer by the following description, and the object and effect of the present disclosure are not limited only by the following description. In addition, in describing the present disclosure, if it is determined that the description of the known technology related to the present disclosure may unnecessarily obscure the gist of the present disclosure, the detailed description thereof will be omitted.

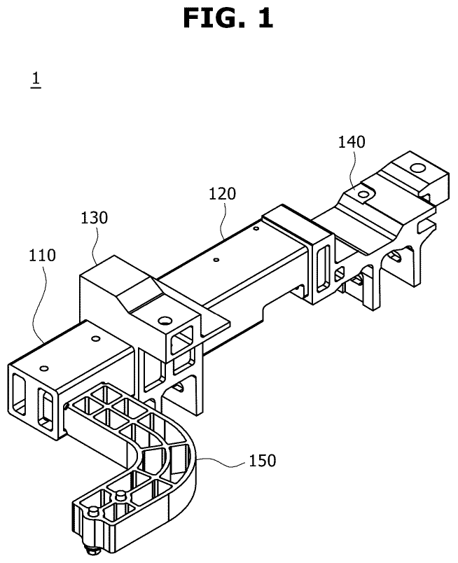

FIG. 1 is a perspective view schematically illustrating a side member 1 of a vehicle according to an embodiment of the present disclosure.

Referring to FIG. 1, the side member 1 of a vehicle includes a front side member 110, a rear side member 120, a first side member connecting part 130, and a second side member connecting part 140.

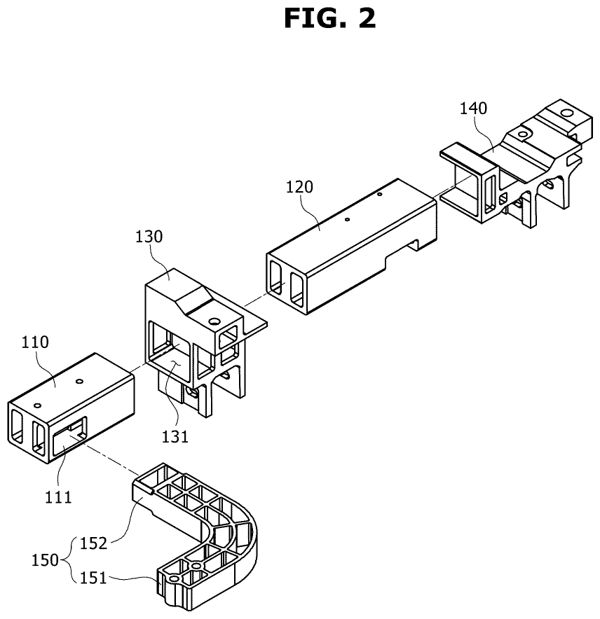

FIG. 2 is an exploded perspective view schematically illustrating the side member of a vehicle according to an embodiment of the present disclosure.

Referring to FIG. 2, the front side member 110, the rear side member 120, the first side member connecting part 130, and the second side member connecting part 140 are assembled and coupled on a single axis.

The side member 1 according to an embodiment of the present disclosure extends in a direction parallel to a longitudinal direction of the vehicle and provides longitudinal rigidity of the vehicle. The side member 1 is provided in a pair and is disposed at a predetermined interval in the width direction of the vehicle.

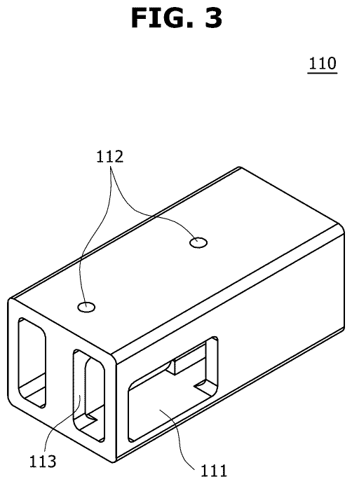

FIG. 3 schematically illustrates the front side member 110 of the side member of a vehicle according to an embodiment of the present disclosure.

Referring to FIG. 3, the front side member 110 extends in the longitudinal direction of the vehicle. The front side member 110 may be provided in a pair in the vehicle, and each front side member 110 is disposed to be spaced apart from each other in a width direction of the vehicle. Screw holes 112 are formed on an upper end of the front side member 110. The screw holes 112 are provided with screw threads, and a suspension part is screw-assembled through the screw holes 112.

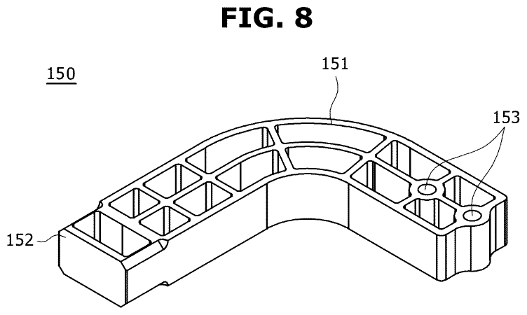

The front side member 110 includes impact bar insertion holes 111. The front side member 110 includes the impact bar insertion holes 111 each having a cross-section corresponding to the cross-section of an impact bar protrusion 152 of FIG. 8 described later, on one side of the front side member 110. Accordingly, the front side member 110 is fitted and assembled with a bracket impact bar 150, so that the front side member 110 and the bracket impact bar 150 can be easily connected.

The side surface of the front side member 110 is divided into a plurality of spaces by a first bulkhead part 113. By providing the first bulkhead part 113 in a hollow portion of the front side member 110, the strength of the front side member 110 may be reinforced. In addition, the first bulkhead part 113 may set the size of the impact bar insertion hole 111. That is, by changing the arrangement of the first bulkhead part 113, the degree to which the bracket impact bar 150 is inserted can be adjusted.

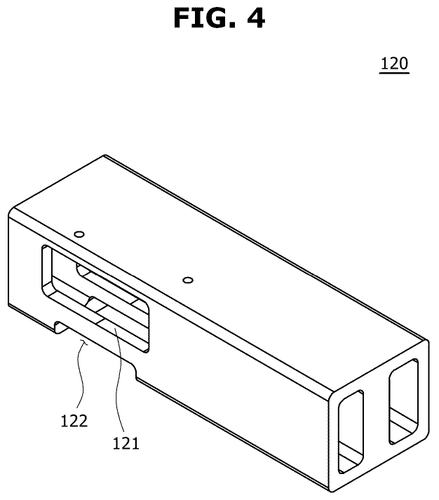

FIG. 4 schematically illustrates the rear side member 120 of the side member of a vehicle according to an embodiment of the present disclosure.

Referring to FIG. 4, the rear side member 120 extends in the longitudinal direction of the vehicle and is provided at the rear of the front side member 110. The rear side member 120 may be provided in a pair in the vehicle, and each rear side member 120 is disposed to be spaced apart from each other in the width direction of the vehicle.

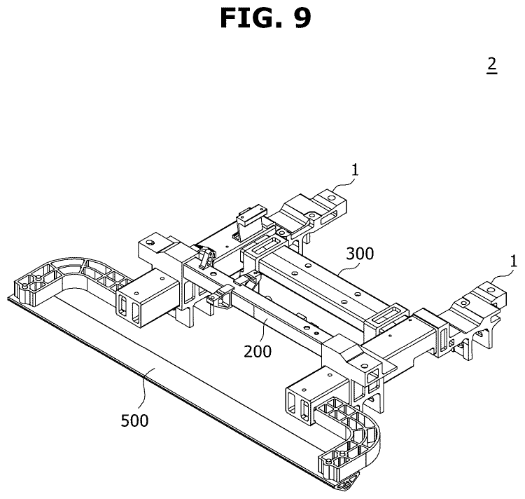

The rear side member 120 includes a second cross member insertion hole 121 having a cross-section corresponding to the cross-section of a rear cross member part 300 in FIG. 9 so that the rear cross member part 300 described later is inserted into the second cross member insertion hole 121. The second cross member insertion hole 121 is provided in a rectangular shape. Both ends of the rear cross member part 300 disposed in the width direction of the vehicle is inserted into the second cross member insertion hole 121.

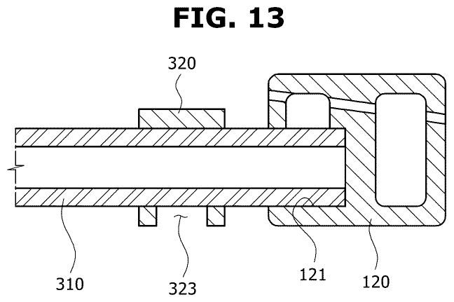

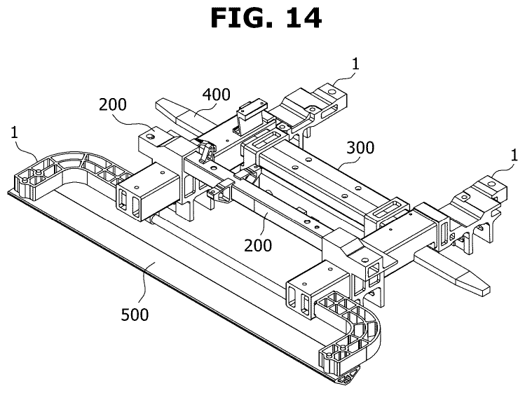

The rear side member 120 includes a buffer seating part 122 at the bottom. A buffer part 400 of FIG. 14 described later is seated at the bottom of the buffer seating part 122. The buffer seating part 122 is connected to a buffer groove 323 of FIG. 13 provided in the rear cross member part 300.

The rear side member 120 has the same cross-sectional shape as the front side member 110. That is, the front side member 110 and the rear side member 120 are extruded with the same cross-section.

The front side member 110 and the rear side member 120 form a main frame of the side member 1. In this case, the side member 1 forming the side of the subframe 2 of the vehicle is provided with a constant width so as to support the vehicle body with high rigidity. Accordingly, each of the front side member 110 and the rear side member 120 is formed with a constant width.

As the front side member 110 and the rear side member 120 are extruded with the same cross-section, the front side member 110 and the rear side member 120 are formed with a certain width. In addition, after the front side member 110 and the rear side member 120 are extruded, the front side member 110 and the rear side member 120 are cut to a length that fits the specifications of the vehicle.

Accordingly, the side member 1 according to an embodiment of the present disclosure is formed with the front side member 110 and the rear side member 120 having the same width, thereby improving durability, and can correspond to the specifications of the vehicle body through a technique of extruding and cutting or sawing processing.

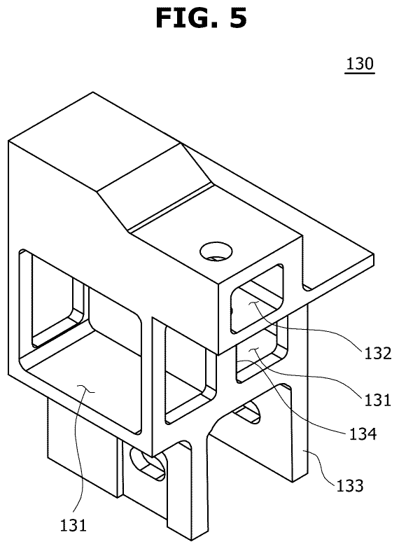

FIG. 5 schematically illustrates the first side member connecting part 130 of the side member of a vehicle according to an embodiment of the present disclosure.

Referring to FIG. 5, the first side member connecting part 130 is provided with first insertion holes 131 into which the front side member 110 and the rear side member 120 are respectively inserted so that the front side member 110 and the rear side member 120 are disposed in series.

The front side member 110 is inserted into one side of the first side member connecting part 130, and the rear side member 120 is inserted into the other side of the first side member connecting part 130. Because the cross-sections of the front side member 110 and the rear side member 120 are extruded with the same shape, the first insertion holes 131 into which the front side member 110 and the rear side member 120 are inserted may be provided with the same cross-sectional shape as the front side member 110 and the rear side member 120.

A first mounting hole 133 to which a front lower arm mounting (not shown) can be connected is provided at the bottom of the first side member connecting part 130. Unlike the case where the first mounting hole 133 is disposed on the front side member 110 or the rear side member 120, the first mounting hole 133 is disposed on the first side member connecting part 130, so that the front lower arm mounting may be stably connected without being biased.

A second bulkhead part 134 is disposed between the adjacent first insertion holes 131 of the first side member connecting part 130. The front side member 110 and the rear side member 120 are in surface contact on both sides of the second bulkhead part 134. The second bulkhead part 134 supports the load of the first side member connecting part 130 and reinforces the strength of the first side member connecting part 130.

The second bulkhead 134 is disposed to adjust the lengths of the front side member 110 and the rear side member 120. For example, when the length of the front side member 110 is set short and the length of the rear side member 120 is set long, the front side member 110 and the rear side member 120 are cut after extruding and connected to the second bulkhead 134 to be in contact with the second bulkhead 134 so that the lengths of the front side member 110 and the rear side member 120 may be precisely adjusted differently. Accordingly, the dimensional accuracy of the side member 1 of the vehicle according to an embodiment of the present disclosure may be improved.

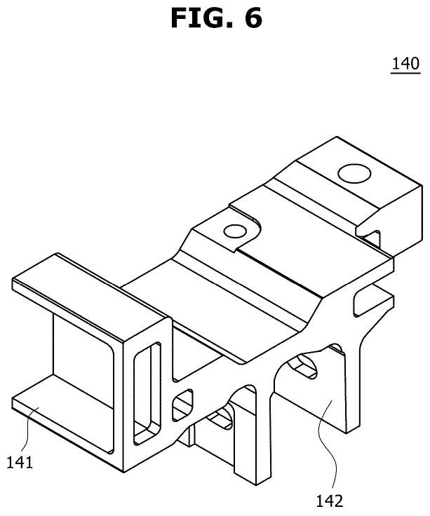

FIG. 6 schematically illustrates the second side member connecting part 140 of the side member of a vehicle according to an embodiment of the present disclosure.

Referring to FIG. 6, the second side member connecting part 140 is provided with a second insertion hole 141 into which the rear side member 120 is inserted.

The second insertion hole 141 is provided on the left side based on FIG. 6. As with the first insertion hole 131, the second insertion hole 141 has a cross-sectional shape that matches the cross-sectional shape of the rear side member 120. One end of the rear side member 120 is inserted into the first insertion hole 131, and the other end of the rear side member 120 is inserted into the second insertion hole 141.

A second mounting hole 142 is provided at the bottom of the rear side member 120 into which a rear lower arm mounting (not shown) may be assembled. The rear lower arm mounting is inserted into and coupled to the second mounting hole 142.

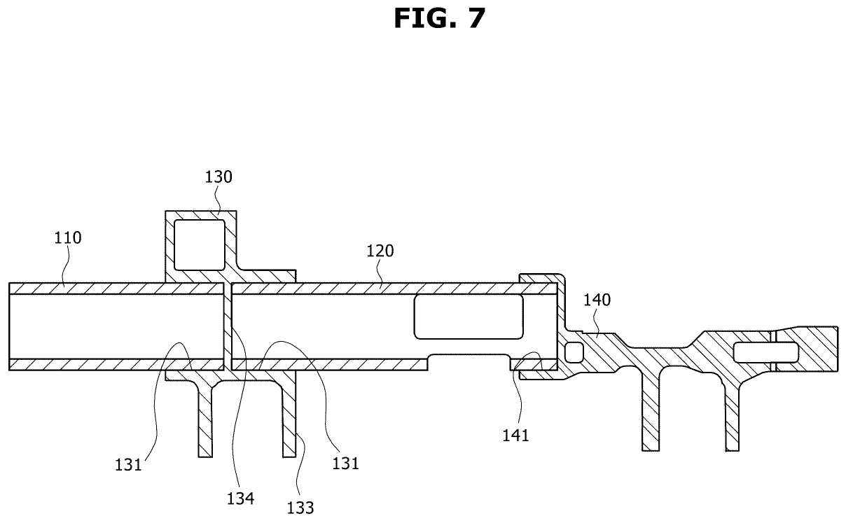

FIG. 7 schematically illustrates a connection relationship of the side member 1 of a vehicle according to an embodiment of the present disclosure.

Referring to FIG. 7, the front side member 110 and the rear side member 120 of the side member 1 according to an embodiment of the present disclosure is disposed in series through the first side member connecting part 130. Accordingly, the front side member 110, the rear side member 120, and the first side member connecting part 130 and the second side member connecting part 140 connecting the front side member 110 and the rear side member 120 are provided on one axis as shown in FIG. 7.

The first side member connecting part 130 is disposed between the front side member 110 and the rear side member 120. As a result, the front side member 110 and the rear side member 120 do not collide when the vehicle body vibrates, and durability and rigidity may be secured.

FIG. 8 schematically illustrates a bracket impact bar 150 of the side member of a vehicle according to an embodiment of the present disclosure.

Referring to FIG. 8, the side member 1 of a vehicle according to an embodiment of the present disclosure further includes the bracket impact bar 150 that is fitted to the side of the front side member 110 and absorbs impact transmitted to the vehicle body.

The bracket impact bar 150 includes an impact bar body 151 and an impact bar protrusion 152.

The impact bar body 151 is provided with assembly holes 153 in which a screw thread is formed at one end. The impact bar body 151 is screw-connected to a bumper impact bar 500 of FIG. 9 described later through the assembly holes 153 having the screw thread formed therein. As a result, the bracket impact bar 150 may absorb the impact transmitted from the bumper impact bar 500.

The impact bar protrusion 152 extends outward from the impact bar body 151 and has a narrower width than the impact bar body 151. Because the impact bar protrusion 152 has a chamfered surface, the width of the impact bar protrusion 152 is narrower than the width of the impact bar body 151. Accordingly, as the narrowed impact bar protrusion 152 is inserted into the impact bar insertion hole 111 of FIG. 3, having a cross-section corresponding to the cross-section of the impact bar protrusion 152, the bracket impact bar 150 and the front side member 110 may be fitted together.

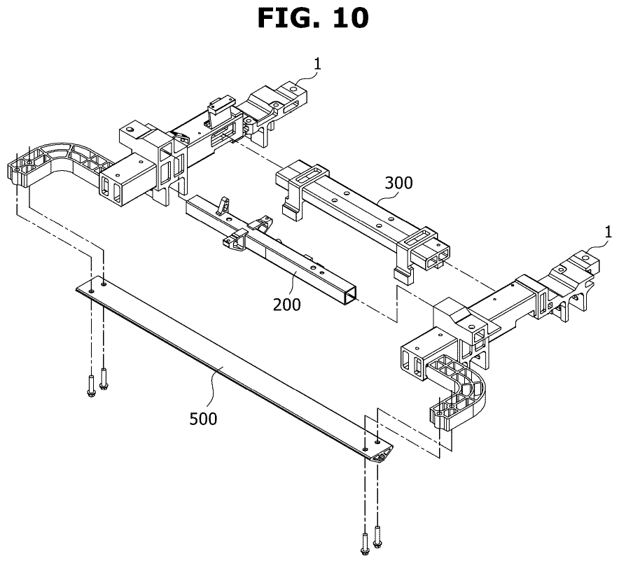

FIG. 9 schematically illustrates a subframe 2 of a vehicle according to an embodiment of the present disclosure, and FIG. 10 is an exploded perspective view schematically illustrating the subframe of a vehicle according to an embodiment of the present disclosure.

Referring to FIG. 9 and FIG. 10, the subframe 2 of a vehicle includes a pair of side members 1, a front cross member part 200, and a rear cross member part 300.

The pair of side members 1 are disposed from each other spaced apart in a width direction of the vehicle. Each side member 1 includes a front side member 110, a rear side member 120, a first side member connecting part 130, and a second side member connecting part 140.

The configurations of the front side member 110, the rear side member 120, the first side member connecting part 130, and the second side member connecting part 140 are obvious from the description based on FIG. 1 to FIG. 8, and thus, for the convenience of explanation, a detailed description thereof will be omitted. In explaining the subframe 2 for the vehicle according to the present embodiment, the drawing symbols of the side member part 1 described based on FIG. 1 to FIG. 8 are set to be the same.

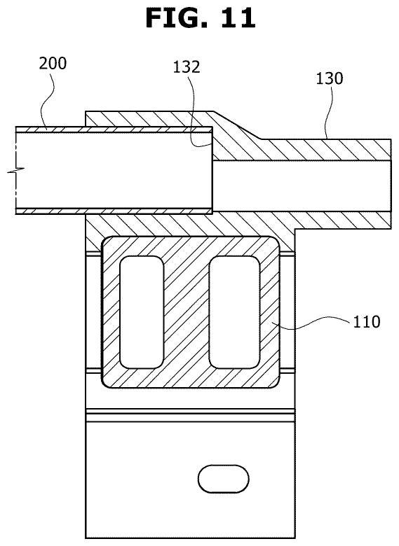

FIG. 11 schematically illustrates a connection relationship between the front side member and the side member of the subframe of a vehicle according to an embodiment of the present disclosure.

A front cross member part 200 is disposed in a width direction of the vehicle, and both ends of the front cross member part 200 are fitted to the pair of side members 1 of FIG. 10.

Specifically, the first side member connecting part 130 includes a first cross member insertion hole 132 having a cross-section corresponding to the cross-section of the front cross member part 200 so that the front cross member part 200 is fitted therein. Accordingly, by fitting the front cross member part 200 into the first cross member insertion hole 132, the first side member connection part 130 and the front cross member part 200 may be connected. Thereafter, rigidity may be secured through welding.

Referring to FIG. 11, the first cross member insertion hole 132 is provided with a step to adjust the insertion width so that only a part of the front cross member part 200 passes through the first cross member insertion hole 132. The step acts as a stopper, and may adjust the length at which the front cross member part 200 is disposed.

The rear side member 120 is disposed in the width direction of the vehicle, is located at the rear of the front cross member part 200, and both ends may be fitted to the pair of side members 1.

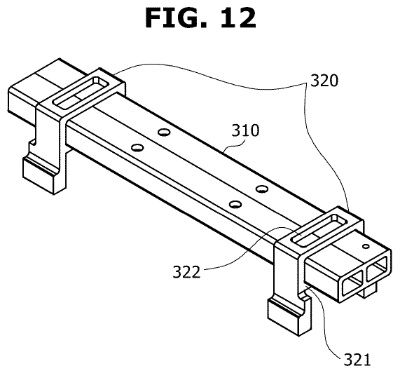

FIG. 12 schematically illustrates a rear cross member part 300 of the subframe of a vehicle according to an embodiment of the present disclosure.

Referring to FIG. 12, the rear cross member part 300 includes a rear cross member 310 that is fitted into the rear side member 120 and a rear cross member bracket 320 that passes through the rear cross member 310 and supports the rear cross member 310.

FIG. 13 schematically illustrates a connection relationship between the rear cross member part 300 and the rear side member 120 of the subframe of a vehicle according to an embodiment of the present disclosure.

Referring to FIG. 13, the rear side member 120 includes a second cross member insertion hole 121 having a cross-section corresponding to the cross-section of the rear cross member part 300 so that the rear cross member part 300 is fitted. By fitting both ends of the rear cross member 310 into the second cross member insertion hole 121 of the rear side member 120 without a gap, the rigidity of the subframe 2 for the vehicle according to the embodiment of the present disclosure may be increased.

The rear cross member 310 is aligned centrally in the width direction of the vehicle and is provided with a buffer part 400 at the bottom to secure the internal strength of the subframe 2 against the load of the vehicle body while the vehicle is driving.

The rear cross member bracket 320 has square holes machined on the side and top and two holes with screw threads machined on the bottom. A side square hole 321 of the rear cross member bracket 320 matches the cross-section of the rear cross member 310. A top square hole 322 of the rear cross member bracket 320 is disposed for additional welding with the rear cross member 310. As a result, the rigidity of the rear cross member part 300 may be secured.

FIG. 14 schematically illustrates the buffer part 400 of the subframe of a vehicle according to an embodiment of the present disclosure.

Referring to FIG. 14 along with FIG. 13, the subframe of a vehicle according to an embodiment of the present disclosure is provided in a longitudinal direction of the rear cross member part 300 and further includes the buffer part 400 assembled to the rear cross member 300.

The buffer part 400 may be provided as a leaf spring that replaces a conventional coil spring. The leaf spring supports the load applied when the vehicle starts suddenly and stops suddenly, thereby ensuring stable driving.

The leaf spring includes glass fiber reinforced plastic (GFRP) material. In addition, the leaf spring includes materials reinforced with fibers, thread-like crystals, and finely dispersed particles in addition to basic materials such as polymers, metals, carbon, and ceramics to prevent fatigue failure or corrosion due to salt moisture in winter.

The rear cross member bracket 320 is provided with a buffer groove 323 on the bottom in which the buffer part 400 is mounted. Referring to FIG. 13, the buffer part 400 is mounted in the concavely formed buffer groove 323.

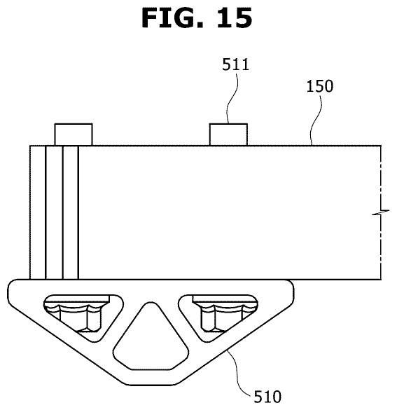

FIG. 15 schematically illustrates a bumper impact bar 500 of the subframe of a vehicle according to an embodiment of the present disclosure.

Referring to FIG. 15, the subframe 2 of a vehicle according to an embodiment of the present disclosure further includes the bumper impact bar 500 including a bracket impact bar 150 that is fitted to the side of the front side member 110 to absorb impact transmitted to the vehicle body and an escape part 510 that is assembled to the bracket impact bar 150 with a connecting member 511 and surrounds the connecting member 511 to prevent damage to the connecting member 511.

In this embodiment, the bracket impact bar 150 and the bumper impact bar 500 are described as being screw-connected as an example, but the present disclosure is not limited to this example and various modifications are possible. The connecting member 511 may be a bolt.

When the bracket impact bar 150 and the bumper impact bar 500 are connected with bolts as shown in FIG. 15, the bolts may protrude outward and the bumper impact bar 500 may be provided with a cover 510 surrounding the bolts to prevent damage caused by the bolts.

In this embodiment, the escape part 510 is provided in a triangular shape. Accordingly, the escape part 510 may efficiently protect the connecting member 511 without unnecessarily wasting space by surrounding only the connecting member 511.

Each of the side member 1, the bracket impact bar, the bumper impact bar, the front cross member part 200, and the rear cross member part 300 may be extruded. After extrusion, the side member 1, the bracket impact bar, the bumper impact bar, the front cross member part 200, and the rear cross member part 300 are cut or sawed to fit the specifications of the vehicle, it is possible to respond to different specifications among vehicle models.

In addition, each of the side member 1, the bracket impact bar, the bumper impact bar, the front cross member part 200, and the rear cross member part 300 includes an aluminum material, thereby reducing the weight of the vehicle body while firmly supporting the load applied when the vehicle is driven and simplifying the structure of the vehicle subframe 2.

Accordingly, the following effects may be obtained in a side member of a vehicle and a subframe of a vehicle including the same, according to an embodiment of the present disclosure.

The side member of a vehicle and the subframe of a vehicle including the same according to the present disclosure can increase the rigidity by a fitting method without excessively increasing the weight of the vehicle.

The side member of a vehicle according to the present disclosure and the subframe of a vehicle including the same are manufactured using an aluminum alloy material and extrusion molding to reduce the weight of the vehicle.

The side member of a vehicle and the subframe of a vehicle including the same according to the present disclosure can effectively support the load transmitted to the vehicle body by the buffer part.

The side member of a vehicle and the subframe for the vehicle including the same according to the present disclosure can secure the durability performance of a suspension device and the chassis module by the buffer part.

The side member of a vehicle and the subframe of a vehicle including the same according to the present disclosure can simplify the structure by the fitting method and shorten the process time.

The side member of a vehicle and the subframe of a vehicle including the same according to the present disclosure can be easily compatible with specifications between vehicle models by cutting and sawing processing aluminum extrusion.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A side member of a vehicle comprising:
a front side member extending in a longitudinal direction of the vehicle;
a rear side member extending in the longitudinal direction of the vehicle and disposed at a rear of the front side member;
a first side member connecting part having first insertion holes into which the front side member and the rear side member are inserted; and
a second side member connecting part having a second insertion hole into which the rear side member is inserted.

2. The side member of claim 1, further comprising a bracket impact bar fitted to a side of the front side member to absorb impact transmitted to a vehicle body.

3. The side member of claim 2,
wherein the bracket impact bar comprises:
an impact bar body having an assembly hole in which a screw thread is formed; and
an impact bar protrusion extending outwardly from the impact bar body and having a narrower width than the impact bar body,
wherein the front side member comprises an impact bar insertion hole having a cross-section corresponding to a cross-section of the impact bar protrusion.

4. A subframe of a vehicle comprising:
a pair of side members spaced apart in a width direction of the vehicle;
a front cross member part disposed in the width direction of the vehicle and having both ends fitted to the pair of side members; and
a rear cross member part disposed in the width direction of the vehicle, disposed at the rear of the front cross member, and having both ends fitted into the pair of side members,
wherein each of the side members comprises:
front side members spaced apart in the width direction of the vehicle;
rear side members spaced apart in the width direction of the vehicle and disposed at the rear of the front side members;
a first side member connecting part having first insertion holes into which the front side member and the rear side member are respectively inserted; and
a second side member connecting part having second insertion holes into which the rear side members are inserted.

5. The subframe of claim 4, wherein the first side member connecting part comprises a first cross member insertion hole having a cross-section corresponding to a cross-section of the front cross member part so that the front cross member part is fitted therein.

6. The subframe of claim 4, wherein the rear side member comprises a second cross member insertion hole having a cross-section corresponding to the cross-section of the rear cross member so that the rear cross member is fitted therein.

7. The subframe of claim 4, wherein the rear cross member part comprises:
a rear cross member fitted to the rear side member; and
a rear cross member bracket that passes through the rear cross member and supports the rear cross member.

8. The subframe of claim 7, further comprising a buffer part disposed in a longitudinal direction of the rear cross member part and assembled to the rear cross member part.

9. The subframe of claim 8, wherein the rear cross member bracket has a buffer groove at the bottom in which the buffer part is mounted.

10. The subframe of claim 9, further comprising:
a bracket impact bar fitted to the side of the front side member to absorb impact transmitted to a vehicle body; and
a bumper impact bar assembled to the bracket impact bar with a connecting member and having an escape part surrounding the connecting member to prevent damage of the connecting member.
